(19) United States
(12) Patent Application Publication
(10) Pub. No.: US 2011/0202543 A1
(43) Pub. Date: Aug. 18, 2011

(54) OPTIMISING CONTENT BASED IMAGE RETRIEVAL

(75) Inventors: Peter Koon CHIN, North Sydney (AU); Trevor Gerald CAMPBELL, North Sydney (AU); Ting SHAN, North Sydney (AU)

(73) Assignee: IMPREZZEO PTY LIMITED, St. Lucia (AU)

(21) Appl. No.: 13/028,781

(22) Filed: Feb. 16, 2011

(30) Foreign Application Priority Data
Feb. 16, 2010 (AU) 2010900623

(51) Int. Cl. G06F 17/30

(52) U.S. Cl. 707/749; 707/E17.02

(57) ABSTRACT

A method, processing system and computer program product for optimising a search of a collection of images. In one aspect, the method includes iteratively performing, in a processing system, steps of comparing a test search result set for a search query to a user defined expected search result set for the search query, wherein the search query includes a query feature set of a search image, each feature being associated with a weight; and adjusting one or more weights of the query feature set according to the results of the comparison to improve the similarity between the test and expected search result sets, thereby optimising a future image search of the collection of images.

### CROSS-REFERENCE TO RELATED APPLICATIONS

This application claims the benefit of priority from Australian Provisional Application No. 2010900623, filed on Feb. 16, 2010, which is hereby incorporated by reference in its entirety.

### TECHNICAL FIELD

The present invention generally relates to identification, searching and/or retrieval of digital images. The present invention more particularly relates to a method, processing system and/or a computer program product for determining a set of weights of a feature set of a search query for optimising Content Based Image Retrieval (CBIR) techniques.

### BACKGROUND

Retrieval of mages from a relatively large collection of reference images remains a significant problem. It is generally considered impractical for a user to simply browse a relatively large collection of images, for example thumbnail images, so as to select a desired image. Traditionally, images have been indexed by keyword(s) allowing a user to search the images based on associated keywords, with the results being presented using some form of keyword based relevancy test. Such an approach is fraught with difficulties since keyword selection and allocation generally requires human tagging, which is a time intensive process, and many images can be described by multiple or different keywords.

Alternative approaches have been proposed utilising a processing system to perform Content Based Image Retrieval. It has been found that more accurate image retrieval results can be obtained by constructing search queries using a plurality of searchable features, such as texture, hue, contrast etc. However, the importance of each feature can vary for each collection of images being searched and can have significant impact upon the accuracy of the search results.

Therefore, there is a need to provide a method, processing system, and/or a computer program product which overcomes or at least ameliorates the above mentioned disadvantages.

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

### BRIEF SUMMARY

In one broad aspect there is provided a method of optimising a search of a collection of images, wherein the method includes iteratively performing, in a processing system, steps of:

comparing a test search result set for a search query to a user defined expected search result set for the search query, wherein the search query includes a query feature set of a search image, each feature being associated with a weight; and

adjusting one or more weights of the query feature set according to the results of the comparison to improve the similarity between the test and expected search result sets, thereby optimising a future image search of the collection of images.

In one form, the method includes:

presenting, to the user, a previous search result set including one or more images returned as a result of performing the search using the search query; and

receiving, from the user, an adjustment to the previous search result set of the search query to define the expected search result set.

In another form, the adjustment to the search result set of the search query includes at least one of:

an addition of one or more images to the previous search result set from the collection of images;

a subtraction of one or more images from the previous search result set.

In one embodiment, the method includes:

determining an overlap between the test search result set and the expected search result set; and

determining if an overlap condition has been satisfied based upon the overlap, wherein in the event of the overlap condition not being satisfied, the one or more weights of the query feature set are adjusted accordingly.

In another embodiment, the adjustment to the one or more weights includes at least one of:

the processing system automatically adjusting the one or more weights of the query feature set; and

the user defining one or more adjustments to the one or more weights of the query feature set.

In an optional form, in the event of the overlap condition having been satisfied, the method includes storing an association between an identity of the collection of images and the one or more weights, wherein the one or more weights are retrieved and applied when conducting future searches of the collection of images.

In another optional form, the method includes defining a plurality of search queries and a plurality of expected search result sets, wherein the one or more weights are adjusted according to a plurality of test search result sets generated for the plurality of search queries and the associated query feature sets for the respective search images.

In another broad aspect there is provided a processing system for optimising a search of a collection of images, wherein the processing system includes iteratively perform steps of:

compare a test search result set for a search query to a user defined expected search result set for the search query, wherein the search query includes a query feature set of a search image, each feature being associated with a weight; and

adjust one or more weights of the query feature set according to the results of the comparison to improve the similarity between the test and expected search result sets, thereby optimising a future image search of the collection of images.

In one form, the processing system is configured to:

present, to the user, a previous search result set including one or more images returned as a result of performing the search using the search query; and

receive, from the user, an adjustment to the previous search result set of the search query to define the expected search result set.

In another form, the adjustment to the search result set of the search query includes at least one of:

an addition of one or more images to the previous search result set from the collection of images;

a subtraction of one or more images from the previous search result set.

In one embodiment, the processing system is configured to:

determine an overlap between the test search result set and the expected search result set; and

determine if an overlap condition has been satisfied based upon the overlap, wherein in the event of the overlap condition not being satisfied, the one or more weights of the query feature set are adjusted accordingly.

In another embodiment, the adjustment to the one or more weights includes at least one of:

the processing system being configured to automatically adjust the one or more weights of the query feature set; and

the processing system being configured to receive, from the user, one or more adjustments to the one or more weights of the query feature set.

In an optional form, in the event of the overlap condition having been satisfied, the processing system is configured to store an association between an identity of the collection of images and the one or more weights, wherein the processing system is configured to retrieve and apply the one or more weights when conducting future searches of the collection of images.

In another optional form, the processing system is configured to define a plurality of search queries and a plurality of expected search result sets, wherein the one or more weights are adjusted according to a plurality of test search result sets generated for the plurality of search queries and the associated query feature sets for the respective search images.

In another broad aspect there is provided a computer readable medium including data indicative of a computer program which configures a processing system to iteratively perform steps of:

compare a test search result set for a search query to a user defined expected search result set for the search query, wherein the search query includes a query feature set of a search image, each feature being associated with a weight; and

adjust one or more weights of the query feature set according to the results of the comparison to improve the similarity between the test and expected search result sets, thereby optimising a future image search of the collection of images.

In one form, the computer program product configures the processing system to:

present, to the user, a previous search result set including one or more images returned as a result of performing the search using the search query; and

receive, from the user, an adjustment to the previous search result set of the search query to define the expected search result set.

In another form, the adjustment to the search result set of the search query includes at least one of:

an addition of one or ore images to the previous search result set from the collection of images;

a subtraction of one or more images from the previous search result set.

In one embodiment, the computer program product configures the processing system to:

determine an overlap between the test search result set and the expected search result set; and

determine if an overlap condition has been satisfied based upon the overlap, wherein in the event of the overlap condition not being satisfied, the one or more weights of the query feature set are adjusted accordingly.

In another embodiment, the adjustment to the one or more weights includes at least one of:

the computer program product configuring the processing system to automatically adjust the one or more weights of the query feature set; and

the computer program product configuring the processing system to receive, from the user, one or more adjustments to the one or more weights of the query feature set.

In an optional form, in the event of the overlap condition having been satisfied, the computer program product configures the processing system to store an association between an identity of the collection of images and the one or more weights, wherein the computer program product configures the processing system to retrieve and apply the one or more weights when conducting future searches of the collection of images.

In another optional form, the computer program product configures the processing system to define a plurality of search queries and a plurality of expected search result sets, wherein the one or more weights are adjusted according to a plurality of test search result sets generated for the plurality of search queries and the associated query feature sets for the respective search images.

Other embodiments of the above mentioned broad aspects will be realised throughout the description of the example embodiments.

### BRIEF DESCRIPTION OF THE FIGURES

Example embodiments should become apparent from the following description, which is given by way of example only, of at least one preferred but non-limiting embodiment, described in connection with the accompanying figures.

FIG. 1 illustrates a flowchart showing a method of searching and retrieval of images based on the content of the images;

FIG. 2 illustrates a functional block diagram of an example processing system that can be utilised to embody or give effect to a particular embodiment;

FIG. 3 illustrates a flow chart representing an example method of determining weights for a feature set;

FIG. 4 illustrates a more detailed flow chart representing a more detailed example of determining weights for a feature set; and

FIG. 5 illustrates a process of the user defining an expected search result set based upon previously executed search query.

### PREFERRED EMBODIMENTS

The following modes, given by way of example only, are described in order to provide a more precise understanding of the subject matter of a preferred embodiment or embodiments. In the figures, incorporated to illustrate features of an example embodiment, like reference numerals are used to identify like parts throughout the figures.

In one example form there is provided a method of searching for, identifying and/or retrieving one or more images, for example, but not necessarily, facial images, from a ‘target image set’, being one or more target images (i.e. reference images). The method includes constructing or obtaining a ‘query feature set’ (which may be a single query feature) by identifying, determining, calculating or extracting a ‘set of features’ from ‘one or more selected images’ which define a ‘query image set’ (which may be a single query image).

A ‘distance’ or ‘dissimilarity measurement’ is then determined, calculated or constructed between a ‘query feature’ from the query feature set and a ‘target feature’ from the target image set. For example, the dissimilarity measurement may be obtained as a function of the weighted summation of differences or distances between the query features and the target features over all of the target image set. If there are suitable image matches, ‘one or more identified images’ are identified, obtained and/or extracted from the target image set and can be displayed to a user. Identified images may be selected based on the dissimilarity measurement over all query features, for example by selecting images having a minimum dissimilarity measurement.

The weighted summation uses weights in the query feature set. The order of display of identified images can be ranked, for example based on the dissimilarity measurement. The identified images can be displayed in order from least dissimilar by increasing dissimilarity, although other ranking schemes such as size, age, filename, etc. are also possible. The query feature set may be extracted from a query image set having two or more selected images (selected by the user). The query feature set can be identified, determined and/or extracted using a feature tool such as a software program or computer application.

In one form, the query feature set can be extracted using low level structural descriptions of the query image set (i.e. one or more selected images by a user). For example, the query features or the query feature set could be extracted/selected from one or more of: feature dimensions; feature separations; feature sizes; colour; texture; hue; luminance; structure; feature position; etc.

The query feature set can be viewed, in one form, as an ‘idealized image’ constructed as a weighted sum of the features (represented as ‘feature vectors’ of a query image). For example, the idealized image could be represented as

$$I = {\sum }_{i} {w}_{i} {x}_{i}$$

where xᵢ is a feature and wᵢ is a weight applied to the feature. The weighted summation uses weights derived from the query image set. A program or software application can be used to construct the query feature set by extracting a set of features from the one or more selected images (i.e. the query image set) and construct the dissimilarity measurement.

An example method seeks to identify and retrieve images based on the feature content of the one or more selected images (i.e. the query image set) provided as examples by a user. The query feature set, which the search is based upon, is derived from the one or more example images (i.e. the query image set) supplied or selected by the user. The method extracts a perceptual importance of visual features of images and, in one example, uses a computationally efficient weighted linear dissimilarity measurement or metric that delivers fast and accurate facial image retrieval results.

A query image set Q is a set of example images I typically supplied by a user, so that Q={I_{q1}, I_{q2}, . . . , I_{qQ}}. The set of example selected images may be any number of images, including a single image. A user can provide one, two, three, four, etc. selected images. The user supplied images may be selected directly from a file, document, database and/or may be identified and selected through another image search tool, such as the keyword based Google® Images search tool.

In the following description the target or reference images, sometimes called the image database, is defined as target image set T={Iₘ:m=1, 2, . . . , M}. The query criteria is expressed as a similarity measure S(Q, Iⱼ) between the query Q and a target image Iⱼ in the target image set. A query process Q(Q, S, T) is a mapping of the query image set Q to a permutation Tₚ of the target image set T, according to the similarity function S(Q, Iⱼ), where Tₚ={IₘεT:m=1, 2, . . . , M} is a partially ordered set such that S(Q,Iₘ)>S(Q,Iₘ₊₁). In principle, the permutations are that of the whole image database, in practice only the top ranked output images need be evaluated.

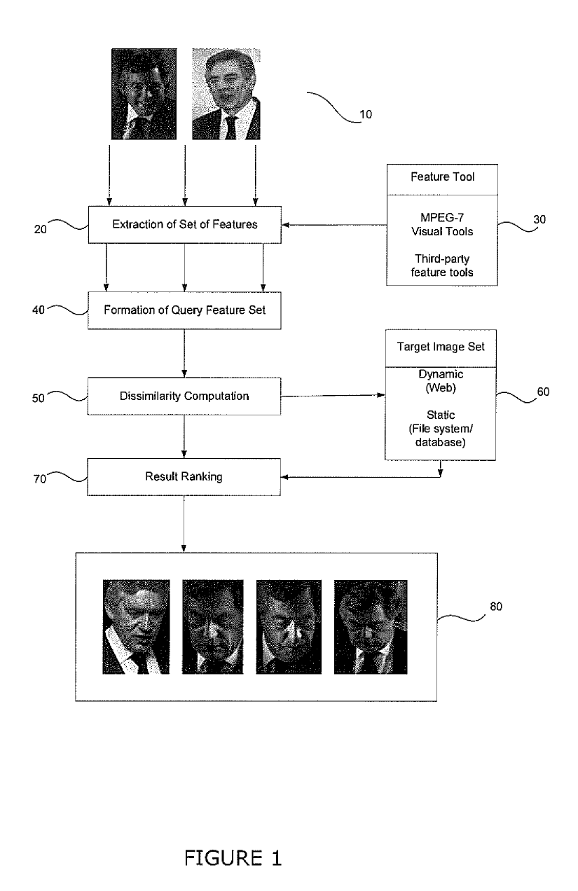

A method of content based image retrieval is illustrated in FIG. 1. The method commences with a user selecting one or more selected images to define the query image set 10. The feature extraction process 20 extracts a set of features from the query image set, for example using feature tool 30 which may be any of a range of third party image feature extraction tools, typically in the form of software applications.

A query feature set is then determined or otherwise constructed at step 40 from the extracted set of features. The query feature set can be conceptually thought of as an idealized image constructed to be representative of the one or more selected images forming the query image set. A dissimilarity measurement/computation is applied at step 50 to one or more target images in the target image set 60 to identify/extract one or more selected images 80 that are deemed sufficiently similar or close to the set of features forming the query feature set. The one or more selected images 80 can be ranked at step 70 and displayed to the user.

### Feature Extraction

The feature extraction process 20 is used to base the query feature set on a low level structural description of the query image set. An image object I can be described by a set of features X={xₙ:n=1, 2, . . . , N}. Each feature is represented by a kₙ-dimensional vector xₙ={x₁, x₂, . . . , xₖₙ} where x_{n,j}ε|0,b_{n,j}|⊂R, and R is a real number. The n^{th} feature extraction is a mapping from image I to the feature vector as:

xₙ=fₙ(I) (1)

The present invention is not limited to extraction of any particular set of features. A variety of visual features, such as colour, texture, objects, etc. can be used. Third party visual feature extraction tools can be used as part of the method or system to extract features.

For example, the popular MPEG-7 visual tool can be suitable. The MPEG-7 Color Layout Descriptor (CLD) is a very compact and resolution-invariant representation of color which is suitable for high-speed image retrieval. MPEG-7 uses only 12 coefficients of 8×8 DCT to describe the content from three sets (six for luminance and three for each chrominance), as expressed as follows:

x_{CLD}=(Y₁, . . . , Y₆,Cb₁,Cb₂,Cb₃,Cr₁,Cr₂,Cr₃) (2)

The MPEG-7 Edge Histogram Descriptor (EHD) uses 80 histogram bins to describe the content from 16 sub-images, as expressed as follows:

x_{EHD}=(h₁, h₂, . . . , h₈₀) (3)

While the MPEG-7 set of tools is useful, there is no limitation to this set of feature extraction tools. There are a range of feature extraction tools that can be used to characterize images according to such features as colour, hue, luminance, structure, texture, location, objects, etc.

### Query Feature Set Formation

The query feature set is implied/determinable by the example images selected by the user (i.e. the one or more selected images forming the query image set). A query feature set formation module generates a ‘virtual query image’ as a query feature set that is derived from the user selected image(s). The query feature set is comprised of query features, typically being vectors.

The fusion of features forming a particular image may be represented by:

xⁱ=(x₁ⁱ⊕x₂ⁱ⊕ . . . ⊕xₙⁱ) (4)

For a query image set the fusion of feature is:

X=(x¹⊕x²⊕ . . . ⊕x^{m}) (5)

The query feature set formation implies an idealized query image which is constructed by weighting each query feature in the query feature set used in the set of features extraction step. The weight applied to the i^{th} feature x, is:

wᵢ=f_{w}ⁱ(x₁¹, x₂¹, . . . , xₙ¹;x₁², x₂², . . . , xₙ²; . . . , x₁^{m}, x₂^{m}, . . . , xₙ^{m}) (6)

The idealized/virtual query image I_{Q} constructed from the query image set Q can be considered to be the weighted sum of query features xᵢ in the query feature set:

$${I}_{Q} = {\sum }_{i} {w}_{i} {x}_{i} \qquad ( 7 )$$

### Dissimilarity Computation

The feature metric space Xₙ is a bounded closed convex subset of the kₙ-dimensional vector space R^{kn}. Therefore, an average, or interval, of feature vectors is a feature vector in the feature set. This is the base for query point movement and query prototype algorithms. However, an average feature vector may not be a good representative of other feature vectors. For instance, the colour grey may not be a good representative of colours white and black.

In the case of a multi-image query image set, the ‘distance’ or ‘dissimilarity’ is measured or calculated between the query image set Q={I_{q1}, I_{q2}, . . . , I_{qQ}} and a target image IⱼεT as:

D(Q,Iⱼ)=D({I_{q1}, I_{q2}, . . . , I_{qQ}},Iⱼ) (8)

In one example, a distance or dissimilarity function expressed as a weighted summation of individual feature distances can be used as follows:

$$D ( {I}_{q} , {I}_{m} ) = {\sum }_{i = 1}^{N} {w}_{i} \cdot {d}_{i} ( {x}_{qi} , {x}_{ni} ) \qquad ( 9 )$$

Equation (9) provides a measurement which is the weighted summation of a distance or dissimilarity metric d between query feature x_{q} and queried target feature xₙ of a target image from the target image set.

The weights wᵢ are updated according to the query image set using equation (6). For instance, the user may be seeking to find images of bright coloured cars. Conventional text based searches cannot assist since the query “car” will retrieve all cars of any colour and a search on “bright cars” will only retrieve images which have been described with these keywords, which is unlikely. However, an initial text search on cars will retrieve a range of cars of various types and colours. When the user chooses one or more selected images that are bright the feature extraction and query formation provides greater weight to the luminance feature than, say, colour or texture. On the other hand if the user is looking for blue cars, the one or more selected images chosen by the user would be only blue cars. The query formation would then give greater weight to the feature colour and to the hue of blue rather than to features for luminance or texture.

In each case the dissimilarity computation is determining a similarity value or measurement that is based on the features of the query feature set (as obtained from the query image set selected by the user) without the user being required to define the particular set of features being sought in the target image set. It will be appreciated that this is an advantageous image searching approach.

### Result Ranking

The image(s) extracted from the target image set using the query image set can be conveniently displayed according to a relevancy ranking. There are several ways to rank the one or more identified images that are output or displayed. One possible and convenient way is to use the dissimilarity measurement described above. That is, the least dissimilar (most similar) identified images are displayed first followed by more dissimilar images up to some number of images or dissimilarity limit. Typically, for example, the twenty least dissimilar identified images might be displayed.

The distance between the images of the query image set and a target image in the database is defined as follows, as is usually defined in a metric space:

$$d ( Q , {I}_{j} ) = {min}_{{I}_{q} ∈ Q} \{ d ( {X}_{q} , {X}_{j} ) \} \qquad ( 10 )$$

The measure of d in equation (10) has the advantage that the top ranked identified images should be similar to one of the example images from the query image set, which is highly expected in an image retrieval system, while in the case of a previously known prototype queries, the top ranked images should be similar to an image of average features, which is not very similar to any of the user selected example images. The present method should thus provide a better or improved searching experience to the user in most applications.

An example software application implementation of the method can use Java Servlet and JavaServer pages technologies supported by an Apache Tomcat® web application server. The application searches for target images based on image content on the Internet, for example via keyword based commercial image search services like Google® or Yahoo®. The application may be accessed using any web browsers, such as Internet Explorer or Mozilla/Firebox, and uses a process to search images from the Internet. In a first step, a keyword based search is used to retrieve images from the Internet via a text based image search service to form an initial image set.

In a second step, a user selects one or more images from the initial search set to form the query image set. Selected images provide examples that the user intends to search on, this can be achieved in one embodiment by the user clicking image checkboxes presented to the user from the keyword based search results. In a third step, the user conducts a search of all target images in one or more image databases using a query feature set constructed from the query image set. Alternatively, it should be appreciated that the one or more selected images fanning the query image set can come from a variety of other image sources, for example a local storage device, web browser cache, software application, document, etc.

According to another example, the method can be integrated into desktop file managers such as Windows Explorer® or Mac OS X Finder®, both of which currently have the capability to browse image files and sort them according to image filenames and other file attributes such as size, file type etc. A typical folder of images is available to a user as a list of thumbnail images. The user can select a number of thumbnail images for constructing the query image set by highlighting or otherwise selecting the images that are closest to a desired image. The user then runs the image retrieval program, which can be conveniently implemented as a web browser plug-in application.

### Initial Image Searching

Preferably, the applications hereinbefore described need not totally replace a user's existing search methodology. Rather, the system/method complements an existing search methodology by providing an image refinement or matching capability. This means that there is no major revamp of a user's methodology, especially in a user interface. By provision as a complementary technology, enhancement of a user's searching experience is sought.

A user's existing search application can be used to specify image requirements. Traditionally, users are comfortable with providing a text description for an initial image search. Once a textual description of the desired image is entered by the user, the user's existing search methodology can be executed to provide an initial list of images that best match the textual description. This is considered an original or initial result set.

These original result images are displayed using a user's existing result display interface. Modifications to the existing results display interface can include the ability for the user to select one or more images as the reference images for refining their image search, i.e. using images to find matching images. Preferably, there is provided functionality in the results display interface (e.g. application GUI) for the user to specify that he/she wants to refine the image search, i.e. inclusion of a ‘Refine Search’ option. Potentially, this could be an additional ‘Refine Search’ button on the results display interface.

When a form of ‘Refine Search’ option is selected, the user's search methodology invokes the image retrieval system to handle the request. The selected images are used as the one or more selected images defining a query image set for performing similarity matches. If required, the search can be configured to search through a complete database to define a new result set.

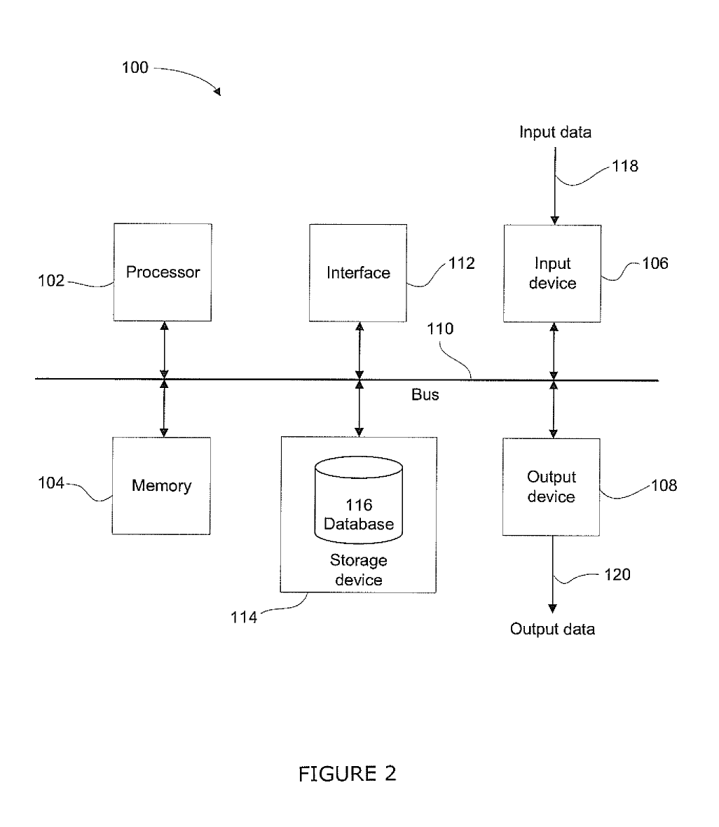

A particular embodiment of the present invention can be realised using a processing system, an example of which is shown in FIG. 2. In particular, the processing system 100 generally includes at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 and can include, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing system 100 may be any form of terminal, server, PC, laptop, notebook, PDA, mobile telephone, specialised hardware, or the like.

### Optimising Weights

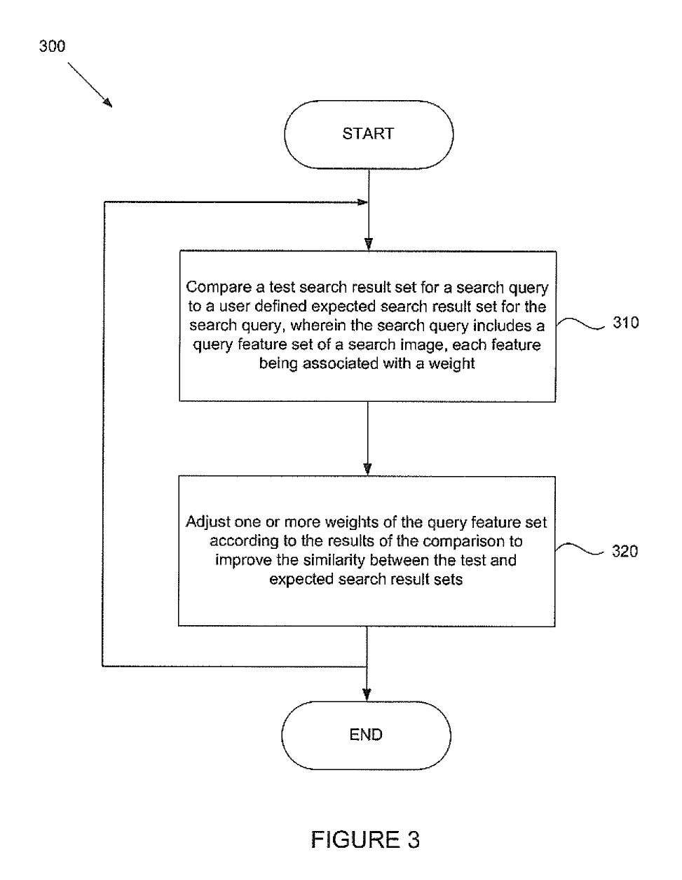

Referring to FIG. 3 there is shown a flow chart representing an example method of optimising content based image retrieval.

In particular, at step 310 the method 300 includes comparing a test search result set for a search query to a user defined expected search result set for the search query, wherein the search query includes a query feature set of a search image, each feature being associated with a weight.

At step 320, the method 300 includes adjusting one or more weights of the query feature set according to the results of the comparison to improve the similarity between the test and expected search result sets, thereby optimising a future image search of the collection of images using the adjusted weights.

As illustrated in FIG. 3, the method 300 can be performed iteratively so that the weights are adjusted over a plurality of iterations in order to optimise future image searches performed upon the collection of images using the adjusted weights.

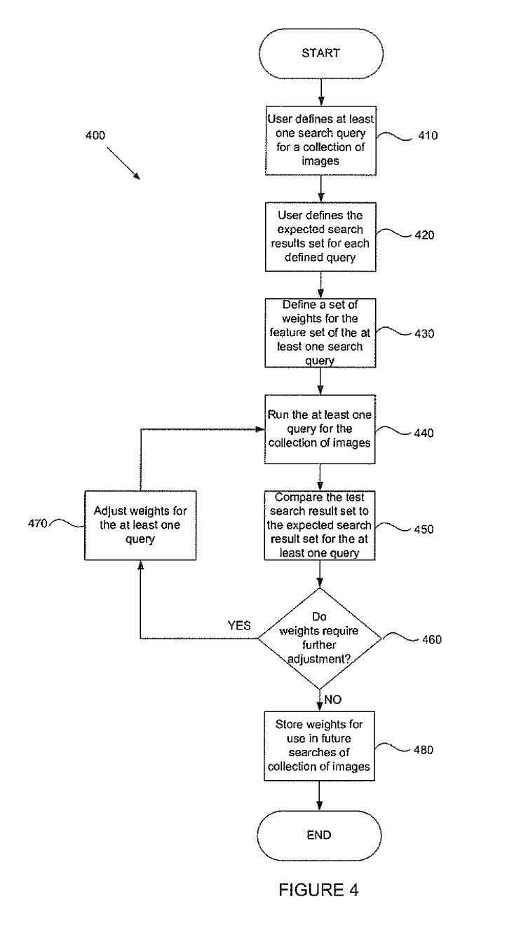

Referring to FIG. 4 there is shown a more detailed method of optimising the content based image retrieval.

In particular, at step 410 the method 400 includes the user defining at least one search query for a collection of images. In a preferable form, the user may define a plurality of search queries for the collection of images in order to determine weights which are generically applicable to a large range of searches conducted for the collection of images rather than a specific type of image search.

Each query generally includes one or more search images which are selected by the user, using the input device of the processing system, wherein the search attempts to identify similar images. The queries may define particular combination of features, such as feature dimensions; feature separations; feature sizes; colour; texture; hue; luminance; structure; feature position etc., which are to be used to generate the search results from the collection of images.

At step 420, the method 400 includes the user defining the expected search results set for each defined query. In particular, the user may select one or more images from the collection of images which the user would expect to be returned upon running the search query for the collection of images. Again, the user may define the expect search results set for each defined query using the input device of the processing system.

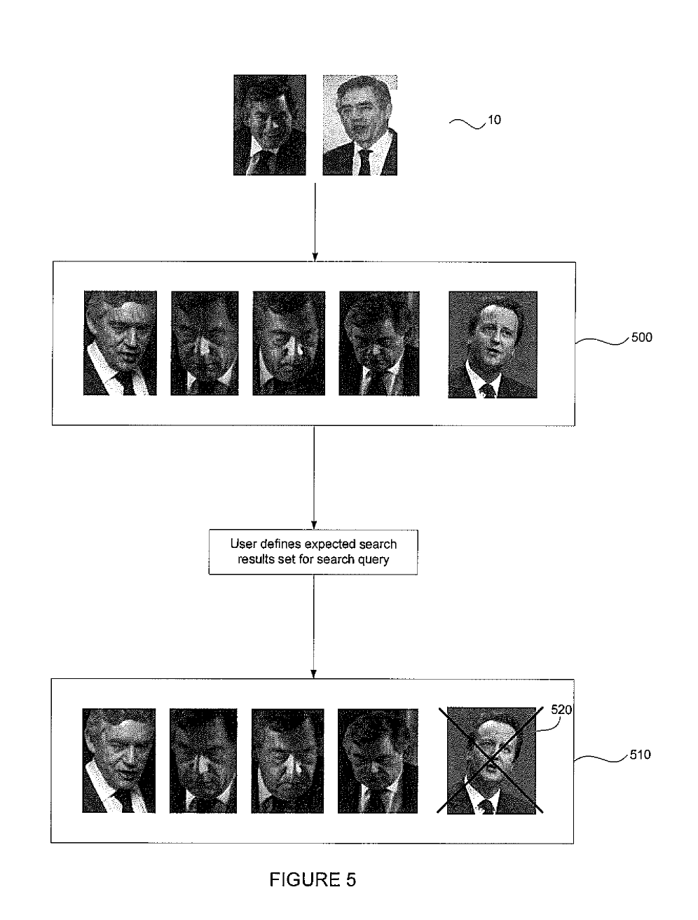

In one form, the user may select previously executed search results from a list of executed searches to determine one or more search result sets which the user believed was reasonable based upon the defined search query. As shown by example in FIG. 5, the user may be presented with the search result set 500 for a previously search query 10. The user may then add further images to the search result set or remove images from the search result set. This is shown by example at 520 wherein one of the images is removed by the user to more clearly define the expected search result set 510 for the defined feature set of the search query 10.

At step 430, the method 400 includes the user defining a set of weights for the feature set of the one or more queries. In one form, the user may select a value for each weight from a range of possible weights available for at least some of the features of the feature set. In one variation, a previously used set of weights for another collection of images maybe initially used for setting the weights of the feature set for the one or more queries. Again, the user may define the weights using the input device of the processing system.

At step 440, the method 400 includes the processor of the processing system running the one or more defined queries for the collection of images. In one form, each image in the collection of images can be assessed according to the dissimilarity measurement for each feature of the feature set. The dissimilarity measurements for the plurality of features are then weighted by the processor of the processing system according to the defined weights. A summation of the weighted dissimilarity measurements is then performed by the processor of the processing system to determine an overall dissimilarity measurement for each image in the collection for each query.

A number of the images may be selected to form the test search result set according to the overall dissimilarity measurement for each image. In particular, the overall dissimilarity measurement for each image may be compared by the processor of the processing system to a threshold value to determine whether the respective image satisfies the respective search query. Alternatively, a predetermined number of images having the lowest overall dissimilarity measurements are selected by the processor of the processing system from the collection of images in order to form the test search result set.

At step 450, the method 400 includes comparing the test search result set for each query to the expected search result set for the respective query. The comparison may simply be a manual comparison by the user of the test and expected search result sets. Additionally or alternatively, the processor of the processing system may perform an analysis of the test and expected search result sets to determine an amount of overlap between the two sets, wherein the amount of overlap between the sets may be used by either the user or the processing system in assessing the performance of the current weights of the feature set for each query.

At step 460, the method includes the processor of the processing system determining if the weights of the feature set are to be adjusted. In one form, the overlap or union between the test and expected search results may be compared to an overlap threshold value to determine if the weights have been optimised to an extent which is considered acceptable. Additionally or alternatively, the user may provide input regarding whether the test search results are considered substantially similar to the expected search results data. In the event that the weights of the feature set are to be adjusted, the method progresses to step 470. In the event that the weights of the feature set are not to be adjusted, the method progresses to step 480.

At step 470, the method includes adjusting the weights for the feature set of the one or more search queries. In one form, the user can adjust one or more of the weights within a range of acceptable values. In another form, the processor of the processing system may make a suggestion of possible changes to the weights based on the similarity between the test and expected search results sets. After step 370, the method returns back to step 340 to again run the search query with the newly adjusted weights.

At step 480, upon determining that the weights no longer require further adjustment due to the test search result set being substantially similar to the expected search result set, the weights of the feature set are stored by the processor of the processing system in a data store. The processor of the processing system also stores, in association with the weights, an identity of the collection of images which the weights have been optimised. Therefore, when future image searches are performed for the image collection, the identity of the image collection can be used to retrieve the optimised weights from the data store by the processor to be used for conducting the search.

In one variation, the adjustment of the one or more weights may be automated by the processor of the processing system for the collection of images. In one form, a simulated annealing process may be implemented by the processor of the processing system, wherein the processor of the processing system attempts to determine the optimal weights of the query feature set by automatically adjusting the weights until a local minimum is determined for a correspondence between the expected search result set and the test search result set. Upon determining a minimum, the user may be prompted as to whether to accept the weights determined by the processor of the processing system.

The above embodiments may take the form of an entirely hardware embodiment, an entirely software embodiment, firmware, or an embodiment combining software and hardware aspects. In one embodiment, a software program may be provided which allows the user to run a number of queries to determine optimum weights for a collection of images. Multiple sets of weights may be stored by the software program for different collections of images.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

1. A method of optimising a search of a collection of images, wherein the method includes iteratively performing, in a processing system, steps of:
comparing a test search result set for a search query to a user defined expected search result set for the search query, wherein the search query includes a query feature set of a search image, each feature being associated with a weight; and
adjusting one or more weights of the query feature set according to the results of the comparison to improve the similarity between the test and expected search result sets, thereby optimising a future image search of the collection of images.

2. The method according to claim 1, wherein the method includes:
presenting, to the user, a previous search result set including one or more images returned as a result of performing the search using the search query; and
receiving, from the user, an adjustment to the previous search result set of the search query to define the expected search result set.

3. The method according to claim 2, wherein the adjustment to the search result set of the search query includes at least one of:
an addition of one or more images to the previous search result set from the collection of images;
a subtraction of one or more images from the previous search result set.

4. The method according to claim 1, wherein the method includes:
determining an overlap between the test search result set and the expected search result set; and
determining if an overlap condition has been satisfied based upon the overlap, wherein in the event of the overlap condition not being satisfied, the one or more weights of the query feature set are adjusted accordingly.

5. The method according to claim 4, wherein the adjustment to the one or more weights includes at least one of:
the processing system automatically adjusting the one or more weights of the query feature set; and
the user defining one or more adjustments to the one or more weights of the query feature set.

6. The method according to claim 4, wherein in the event of the overlap condition having been satisfied, the method includes storing an association between an identity of the collection of images and the one or more weights, wherein the one or more weights are retrieved and applied when conducting future searches of the collection of images.

7. The method according to claim 1, wherein the method includes defining a plurality of search queries and a plurality of expected search result sets, wherein the one or more weights are adjusted according to a plurality of test search result sets generated liar the plurality of search queries and the associated query feature sets for the respective search images.

8. A processing system for optimising a search of a collection of images, wherein the processing system includes iteratively perform steps of:
compare a test search result set for a search query to a user defined expected search result set for the search query, wherein the search query includes a query feature set of a search image, each feature being associated with a weight; and
adjust one or more weights of the query feature set according to the results of the comparison to improve the similarity between the test and expected search result sets, thereby optimising a future image search of the collection of images.

9. The processing system according to claim 8, wherein the processing system is configured to:
present, to the user, a previous search result set including one or more images returned as a result of performing the search using the search query; and
receive, from the user, an adjustment to the previous search result set of the search query to define the expected search result set.

10. The processing system according to claim 9, wherein the adjustment to the search result set of the search query includes at least one of:
an addition of one or more images to the previous search result set from the collection of images;
a subtraction of one or more images from the previous search result set.

11. The processing system according to claim 8, wherein the processing system is configured to:
determine an overlap between the test search result set and the expected search result set; and
determine if an overlap condition has been satisfied based upon the overlap, wherein in the event of the overlap condition not being satisfied, the one or more weights of the query feature set are adjusted accordingly.

12. The processing system according to claim 11, wherein the adjustment to the one or more weights includes at least one of:
the processing system being configured to automatically adjust the one or more weights of the query feature set; and
the processing system being configured to receive, from the user, one or more adjustments to the one or more weights of the query feature set.

13. The processing system according to claim 11, wherein in the event of the overlap condition having been satisfied, the processing system is configured to store an association between an identity of the collection of images and the one or more weights, wherein the processing system is configured to retrieve and apply the one or more weights when conducting future searches of the collection of images.

14. The processing system according to claim 8, wherein the processing system is configured to define a plurality of search queries and a plurality of expected search result sets, wherein the one or more weights are adjusted according to a plurality of test search result sets generated for the plurality of search queries and the associated query feature sets for the respective search images.

15. A computer program product including a computer readable medium including data indicative of a computer program which configures a processing system to iteratively perform steps of
compare a test search result set for a search query to a user defined expected search result set for the search query, wherein the search query includes a query feature set of a search image, each feature being associated with a weight; and
adjust one or more weights of the query feature set according to the results of the comparison to improve the similarity between the test and expected search result sets, thereby optimising a future image search of the collection of images.

16. The computer program product according to claim 15, wherein the computer program product configures the processing system to:
present, to the user, a previous search result set including one or more images returned as a result of performing the search using the search query; and
receive, from the user, an adjustment to the previous search result set of the search query to define the expected search result set.

17. The computer program product according to claim 15, wherein the computer program product configures the processing system to:
determine an overlap between the test search result set and the expected search result set; and
determine if an overlap condition has been satisfied based upon the overlap, wherein in the event of the overlap condition not being satisfied, the one or more weights of the query feature set are adjusted accordingly.

18. The computer program product according to claim 17, wherein the adjustment to the one or more weights includes at least one of:
the computer program product configuring the processing system to automatically adjust the one or more weights of the query feature set; and
the computer program product configuring the processing system to receive, from the user, one or more adjustments to the one or more weights of the query feature set.

19. The computer program product according to claim 17, wherein in the event of the overlap condition having been satisfied, the computer program product configures the processing system to store an association between an identity of the collection of images and the one or more weights, wherein the computer program product configures the processing system to retrieve and apply the one or more weights when conducting future searches of the collection of images.

20. The computer program product according to claim 15, wherein the computer program product configures the processing system to define a plurality of search queries and a plurality of expected search result sets, wherein the one or more weights are adjusted according to a plurality of test search result sets generated for the plurality of search queries and the associated query feature sets for the respective search images.
